(19) United States
(12) Patent Application Publication
(10) Pub. No.: US 2023/0297922 A1
(43) Pub. Date: Sep. 21, 2023

(54) METHODS AND SYSTEMS FOR GENERATION OF PERFORMANCE OPTIMIZATION RECOMMENDATIONS AND RELATED DATA VISUALIZATION

(71) Applicant: TeamStack.ai Corp., Cambridge, MA (US)

(72) Inventors: Susan R. Shultz, Sheboygan, WI (US); Sathia K. Mayandi, Katy, TX (US)

(21) Appl. No.: 18/123,761

(22) Filed: Mar. 20, 2023

Related U.S. Application Data
(60) Provisional application No. 63/322,217, filed on Mar. 21, 2022.

(51) Int. Cl. G06Q 10/0639; G06Q 10/0631

(52) U.S. Cl. CPC G06Q 10/06393; G06Q 10/063114

(57) ABSTRACT

A method includes accessing, by an optimization engine, data identifying a goal associated with a project assigned to a team associated with at least one organization. The optimization engine accesses data identifying a goal associated with the at least one organization. The optimization engine analyzes data relating to at least one characteristic of each of a plurality of members of the team. The optimization engine determines a level of contribution of each of the plurality of members of the team to the goal associated with the at least one organization. The optimization engine determines a level of contribution of each of the plurality of members of the team to the goal associated with the project. The optimization engine determines a likelihood of the team accomplishing the goal associated with the project. The optimization engine modifies a user interface displaying a visualization of the determinations.

### CROSS-REFERENCE TO RELATED APPLICATIONS

This application claims priority from U.S. Provisional Patent Application Ser. No. 63/322,217, filed on Mar. 21, 2022, entitled “Systems and Methods Related to Project Management and Automated Improvement,” which is hereby incorporated by reference.

### BACKGROUND

The disclosure relates to methods for optimizing performance of one or more aspects of a project, team, or entity. More particularly, the methods and systems described herein relate to functionality for generating performance optimization recommendations and related data visualization.

Conventional systems for tracking progress towards completion of a project fail to correlate the attributes of entities contributing effort to the project and goals associated with those entities and with goals associated with some of those entities but not others or with goals independent of the project. Nor do conventional systems typically provide functionality for recommending improvements or modifications to the entities that contribute to monitored projects. Therefore, there is a need for a technical solution that uses pre-project, in-project, and post-project analyses and predictions to generate recommendations for modifying entities contributing to projects and that provides a visualization of the data underlying the analyses.

### BRIEF SUMMARY

A method includes accessing, by an optimization engine, data identifying a goal associated with a project assigned to a team associated with at least one organization. The optimization engine accesses data identifying a goal associated with the at least one organization. The optimization engine analyzes data relating to at least one characteristic of each of a plurality of members of the team. The optimization engine determines a level of contribution of each of the plurality of members of the team to the goal associated with the at least one organization. The optimization engine determines a level of contribution of each of the plurality of members of the team to the goal associated with the project. The optimization engine determines a likelihood of the team accomplishing the goal associated with the project. The optimization engine modifies a user interface displaying a visualization of the determinations.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for generating performance optimization recommendations and modifying a user interface displaying at least one visualization of performance-related data;

FIG. 1B is a block diagram depicting an embodiment of a system for generating performance optimization recommendations and modifying a user interface displaying at least one visualization of performance-related data;

FIG. 1C is a block diagram depicting an embodiment of a user interface generated by a system for generating performance optimization recommendations and modifying a user interface displaying at least one visualization of performance-related data;

FIG. 2 is a flow diagram depicting an embodiment of a method for generating performance optimization recommendations and modifying a user interface displaying at least one visualization of performance-related data;

FIG. 3 is a flow diagram depicting an embodiment of a method for generating performance optimization recommendations and modifying a user interface displaying at least one visualization of performance-related data; and

FIGS. 4A-4C are block diagrams depicting embodiments of computers useful in connection with the methods and systems described herein.

### DETAILED DESCRIPTION

The methods and systems described herein may provide functionality for generating performance optimization recommendations and modifying a user interface displaying at least one visualization of performance-related data.

The methods and systems described herein may provide functionality for pre-project predictive personnel selection as well as optimization of personal to improve project and team performance, in-project updating of personnel performance and project and team performance and post-project review and analysis, and automated reporting and training related thereto. The methods and systems described herein may provide functionality for goal data analysis, personnel selection, goal achievement or success prediction, and for personnel team selection, automated team member training.

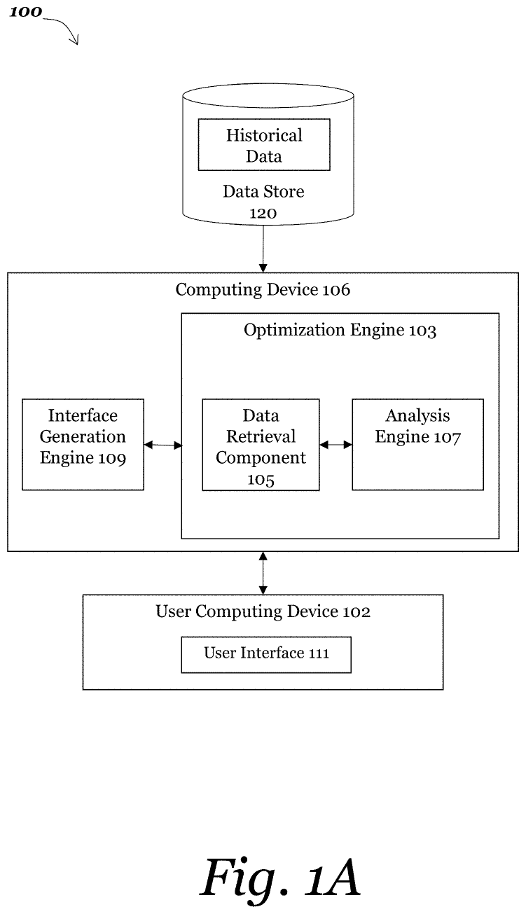

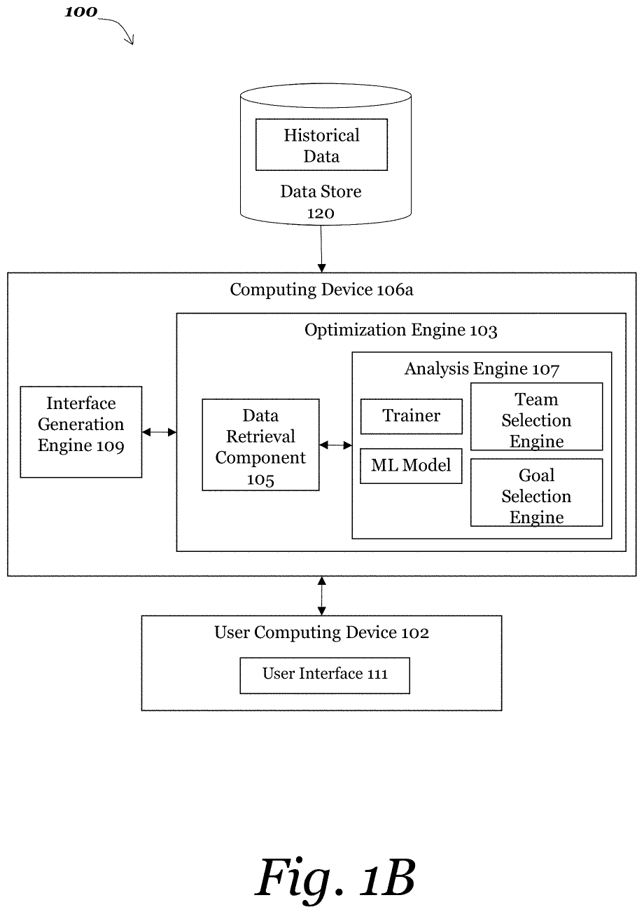

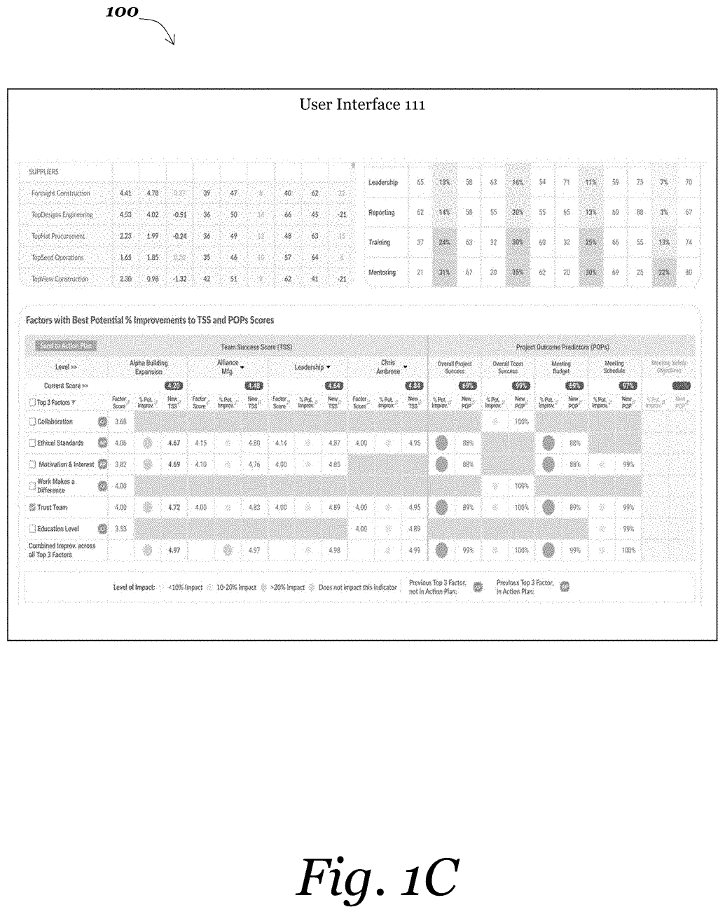

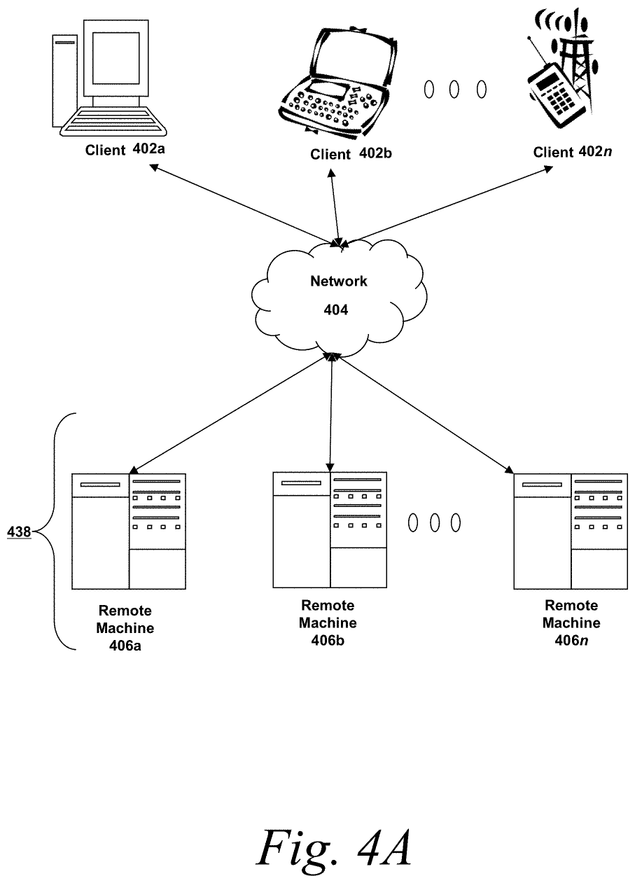

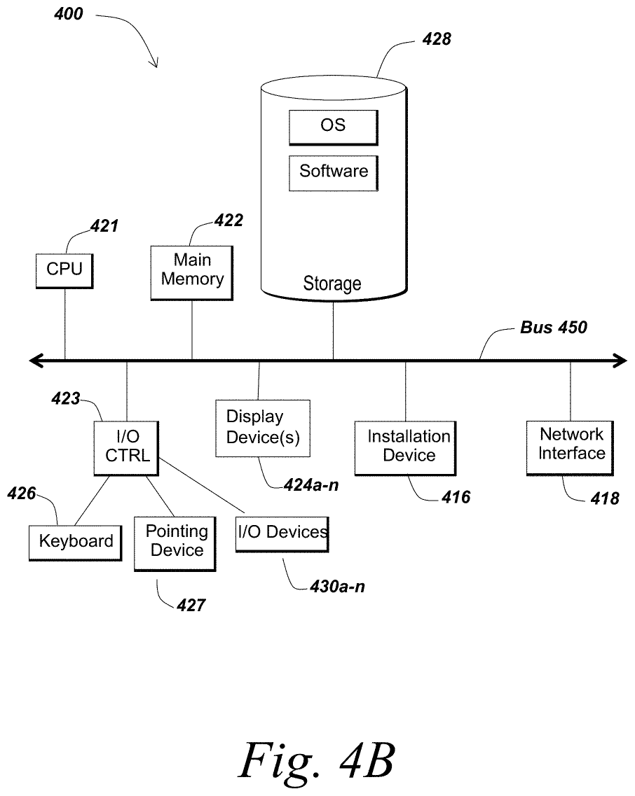

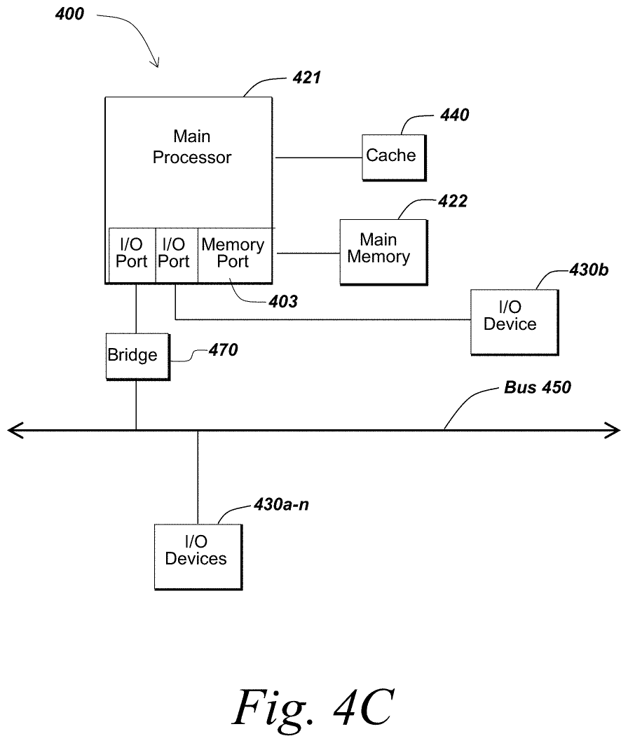

Referring now to FIG. 1A, a block diagram depicts one embodiment of a system 100 for generating performance optimization recommendations and modifying a user interface displaying at least one visualization of performance-related data. In brief overview, the system 100 includes a computing device 106, an optimization engine 103, a data retrieval component 105, an analysis engine 107, an interface generation engine 109, a user computing device 102, a user interface 111, and a data store 120. The computing devices 102 and 106 may be a modified type or form of computing device (as described in greater detail below in connection with FIGS. 4A-C) that have been modified to execute instructions for providing the functionality described herein; these modifications result in a new type of computing device that provides a technical solution to problems rooted in computer technology, such as an automated system for using pre-project, in-project, and post-project analyses to generate recommendations for modifying entities contributing to projects and that provides a visualization of the data underlying the analyses.

The optimization engine 103 may be provided as a software component. The optimization engine 103 may be provided as a hardware component. The computing device 106 may execute the optimization engine 103.

The data retrieval component 105 may be provided as a software component. The data retrieval component 105 may be provided as a hardware component. The computing device 106 may execute the data retrieval component 105. The data retrieval component 105 may execute functionality for retrieving data from one or more data stores 120. The system 100—for example, via the data retrieval component 105—may integrate with one or more other systems including, without limitation, project management systems, human resources systems, performance management systems, design systems, supply chain systems, hiring and training systems, and so on,

The analysis engine 107 may be provided as a software component. The analysis engine 107 may be provided as a hardware component. The computing device 106 may execute the analysis engine 107.

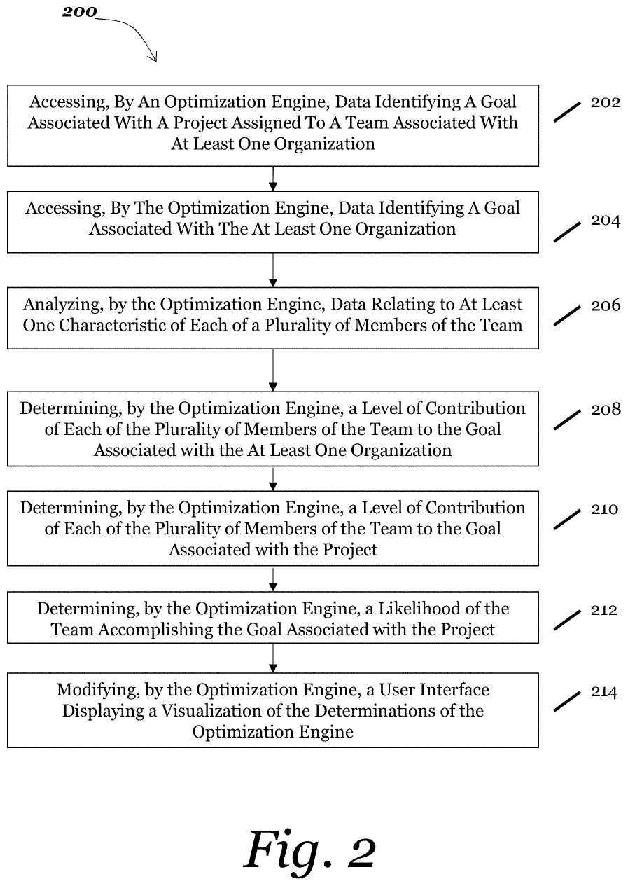

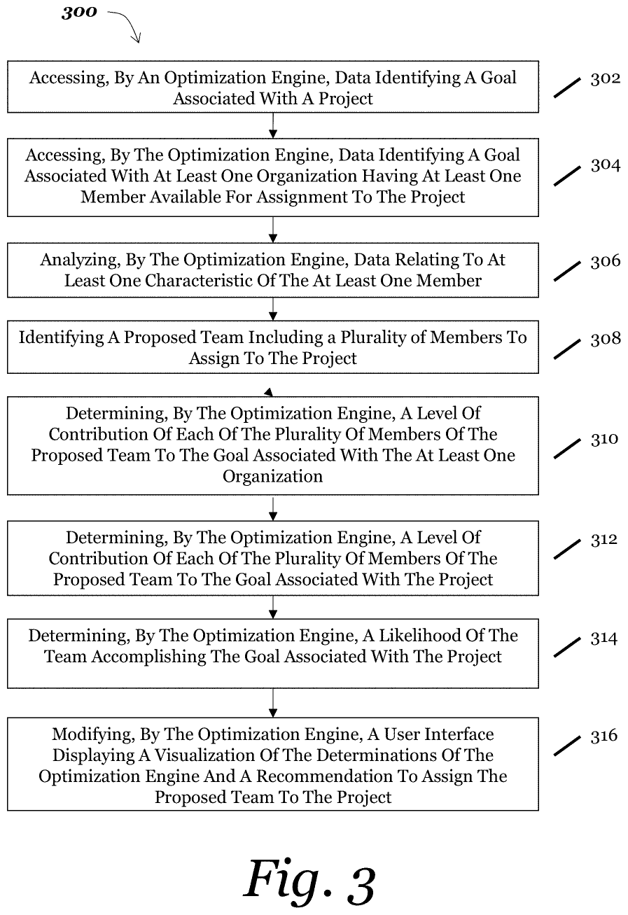

Referring now to FIG. 1B, a block diagram depicts an embodiment of system 100 for generating performance optimization recommendations and modifying a user interface displaying at least one visualization of performance-related data. As depicted in FIG. 1B, the analysis engine 107 may include a machine learning model and a trainer component for training the machine learning model, for example, on historical data retrieved by the data retrieval component. As depicted in FIG. 1B, the analysis engine 107 may include a team selection engine and a goal selection engine for use in performing the various analyses described below in connection with FIGS. 2-3.

Referring back to FIG. 1A, the interface generation engine 109 may be provided as a software component. The interface generation engine 109 may be provided as a hardware component. The computing device 106 may execute the interface generation engine 109. The interface generation engine 109 may execute functionality for directing the user computing device 102 to display at least one user interface 111 on a display of the user computing device 102. The interface generation engine 109 may execute functionality for retrieving output from the optimization engine 103 for use in directing a modification of the user interface 111 displayed by the user computing device 102.

The computing device 106 may include or be in communication with the database 120. The database 120 may store data related to historical data, such as historical project data including information such as project completion data, budgetary data, goals associated with projects, and team member data. The database 120 may store data related to organizations, such as team member data, goals-related data, and data relating to projects to which organizations have contributed. Data may relate to individuals that currently or previously contributed to a team of one or more people involved in one or more current or previous projects.

Although depicted in FIGS. 1A-1B as a single data store 120, the system 100 may include functionality for accessing a plurality of data stores 120 (e.g., by the data retrieval component 105) to retrieve data for analysis by the analysis engine 107. The data store 120 may be an ODBC-compliant database. For example, the data store 120 may be provided as an ORACLE database, manufactured by Oracle Corporation of Redwood Shores, CA. In other embodiments, the data store 120 can be a Microsoft ACCESS database or a Microsoft SQL server database, manufactured by Microsoft Corporation of Redmond, WA. In other embodiments, the data store 120 can be a SQLite database distributed by Hwaci of Charlotte, NC, or a PostgreSQL database distributed by The PostgreSQL Global Development Group. In still other embodiments, the data store 120 may be a custom-designed database based on an open source database, such as the MYSQL family of freely available database products distributed by Oracle Corporation of Redwood City, CA. In other embodiments, examples of databases include, without limitation, structured storage (e.g., NoSQL-type databases and BigTable databases), HBase databases distributed by The Apache Software Foundation of Forest Hill, MD, MongoDB databases distributed by ioGen, Inc., of New York, NY, an AWS DynamoDB distributed by Amazon Web Services and Cassandra databases distributed by The Apache Software Foundation of Forest Hill, MD. In further embodiments, the data store 120 may be any form or type of database.

Although, for ease of discussion, the optimization engine 103, the data retrieval component 105, the analysis engine 107, the interface generation engine 109, and the data store 120 are described in FIG. 1A as separate modules, it should be understood that this does not restrict the architecture to a particular implementation. For instance, these components may be encompassed by a single circuit or software function or, alternatively, distributed across a plurality of computing devices.

Referring now to FIG. 1C, a block diagram depicts an embodiment of a user interface generated by a system 100 for generating performance optimization recommendations and modifying a user interface displaying at least one visualization of performance-related data. As shown in FIG. 1C, the system 100 may generate a user interface 111 displaying an enumeration of supplier teams and associated scores for each of the teams across a plurality of team success score metrics. As shown in FIG. 1C, a user interface 111 further displays an enumeration of project outcome predictors, including scores generated for a likelihood of overall team success, project success, a likelihood of meeting a budget, and a likelihood of meeting a schedule. The user interface 111 further includes user interface elements displaying an amount by which an organization can improve their scores. As shown in FIG. 1C, the systems and methods described herein provide functionality for correlating individual characteristics with an organization's goals, such as, without limitation, Diversity/Equity/Inclusion (DEI) goals or Environment/Safety/Governance (ESG) goals and with project-related and/or organization goals, such as meeting a budget (and other finance-related goals such as those relating to cash flow and profitability), completing on schedule, goals relating to supply chain, and so on, while identifying factors (such as, without limitation, motivation, ethical standards, collaboration skills, education levels, etc.) that the organization or organizations involved in a project may focus on improving in order to improve overall likelihood of succeeding on one or more goals, whether the goals are organizational or project focused.

Referring now to FIG. 2, in brief overview, a block diagram depicts one embodiment of a method 200 for generating performance optimization recommendations and modifying a user interface displaying at least one visualization of performance-related data. The method 200 includes accessing, by an optimization engine, data identifying a goal associated with a project assigned to a team associated with at least one organization (202). The method 200 includes accessing, by the optimization engine, data identifying a goal associated with the at least one organization (204). The method 200 includes analyzing, by the optimization engine, data relating to at least one characteristic of each of a plurality of members of the team (206). The method 200 includes determining, by the optimization engine, a level of contribution of each of the plurality of members of the team to the goal associated with the at least one organization (208). The method 200 includes determining, by the optimization engine, a level of contribution of each of the plurality of members of the team to the goal associated with the project (210). The method 200 includes determining, by the optimization engine, a likelihood of the team accomplishing the goal associated with the project (212). The method 200 includes modifying, by the optimization engine, a user interface displaying a visualization of the determinations of the optimization engine (214).

Referring now to FIG. 2, in greater detail and in connection with FIG. 1, the method 200 includes accessing, by an optimization engine, data identifying a goal associated with a project assigned to a team associated with at least one organization (202). The goal associated with the project may relate to a metric of success such as, without limitation, success in meeting a project deadline, success in satisfying a budgetary requirement, success in meeting a safety requirement, and overall project success based on any one or more specified metrics of success.

The method 200 includes accessing, by the optimization engine, data identifying a goal associated with the at least one organization (204). The goal associated with the organization may relate to a diversity goal. The goal associated with the organization may relate to an equity goal. The goal associated with the organization may relate to an inclusion goal. The goal associated with the organization may relate to an environmental goal. The goal associated with the organization may relate to a social goal. The goal associated with the organization may relate to a human resources goal. The goal associated with the organization may relate to a corporate governance goal. The goal associated with the organization may relate to a performance goal, including without limitation goals relating to profitability and/or cash flow. The goal associated with the organization may relate to a leadership goal.

The system 100 may gather data from users by, for example and without limitation, posing questions directly to users; examples of questions are provided below. Data may be collected from one or more entities associated with the at least one organization and/or with a project stakeholder and then stored in the data store 120. The optimization engine 103 may be configured with pre-identified goals.

The optimization engine 103 may include at least one machine learning model (including, without limitation, other types of artificial intelligence engines, such as natural language processing components, large language models, computer vision engines, and so on) trained on retrieved historical data and current data to generate one or more metrics identifying levels of performance of one or more team members assigned to a project and may generate a predictor of team success based upon its analyses; inputs may include both data about team members, goals for projects, goals of organizations, and historical data. The optimization engine 103 may be trained to assign scores to one or more team members for one or more metrics. As projects are subsequently completed and new data is added to the historical data set and may be used to modify or retrain the analysis engine 107. As will be understood, training a machine learning model or other AI model may include retrieving data, training the model, testing the output of the model, executing the model and retraining the model as new data is received. The system 100 may include training functionality that executes one or more algorithms to train the analysis engine 107 including, without limitation, and by way of example, a RandomForest artificial intelligence (AI) algorithm, VotingEnsemble, StackEnsemble, LogisticRegression, XGBoost, ExtremeRandomTrees, LightGBM, LinearSVM, neural nets (Deep Learning), and other publicly available algorithms published or offered by researchers and/or others in the open source community and usable by various AI platforms, such as Google AI Platform, TensorFlow, Microsoft Azure, IBM Watson Studio, or Amazon SageMaker. The model may be retrained with additional data, modified factor list, algorithms, and other changes to reduce bias and variance and to improve performance on various metrics such as accuracy, precision, recall, specificity, sensitivity, cost/payoff, etc. After training or retraining steps, the analysis engine 107 may identify specific factors for teams or for projects that are correlated with increased levels of likelihood of achieving one or more goals.

The method 200 includes analyzing, by the optimization engine, data relating to at least one characteristic of each of a plurality of members of the team (206). Characteristics of team members may include a wide variety of data. Characteristic data may include, without limitation, data from personal records, hiring-related data, data from reviews, physical or psychological data, data impacting compliance with safety regulations, data from integrated sensors (e.g., body temperature data or ambient temperature data associated with a worker on a construction site or dust or contaminant data in any work environment), data received from facial recognition systems (e.g., checking video conference data for communication challenges such as frequent interruptions or concerning tone or word choice, or data relating to facial expression for correlation with team member engagement), and data from written sources of communication which may be analyzed, for example, by a natural language processing engine of the analysis engine 107 including, for example, memos, emails, team communication from which the system 100 may infer information about how well team members communicate, whom they communicate with, and whether there are team members that should be communicating with other team members but are not yet doing so.

The method 200 includes determining, by the optimization engine, a level of contribution of each of the plurality of members of the team to the goal associated with the at least one organization (208). Levels of contribution relating to organizational goals may refer to how one or more characteristics of a person help or hinder the organization in meeting goals, For example, the optimization engine 103 may analyze information including, without limitation, information about how the person relates to other members of the team, how the person works with other people or types of people, how the person perceives themselves, how the person perceives others.

The method 200 includes determining, by the optimization engine, a level of contribution of each of the plurality of members of the team to the goal associated with the project (210). Levels of contribution relating to project goals may relate to a type of skill or work product a member of the team can contribute to the project.

The method 200 includes determining, by the optimization engine, a likelihood of the team accomplishing the goal associated with the project (212). The method 200 may include determining, by the optimization engine 103, a likelihood of the team accomplishing the goal associated the organization. The method 200 may include determining, by the optimization engine 103, an impact of the likelihood of the team accomplishing one type of goal on the likelihood of the team accomplishing another type of goal (e.g., the impact of a likelihood of success of a project goal on the likelihood of success of an organizational goal). The method 200 may include determining, by the optimization engine 103, the likelihood of the team accomplishing the goal associated with the organization. The method 200 may include determining, by the optimization engine 103, the likelihood of the team accomplishing a goal associated with the team. The method 200 may include determining, by the optimization engine 103, the likelihood of the team accomplishing a goal associated with a team member.

Predictions of probability of success may be direct or indirect. A direct prediction may use team factors and/or project factors to predict a probability of success at an individual (person/team member) level or at a project or project phase (e.g., milestone) level. An indirect prediction may use a direct prediction at the individual level (including all individuals in a project) as a proxy for probability of success at the project level. While different weights may be attributed to different probabilities for different goals, in one example the optimization engine 103 may take a weighted average of direct team member goal probabilities to arrive at project level probabilities for such defined goals.

In some embodiments, the optimization engine 103 may receive input including data relating to factors and goals, generate direct predictions, optionally generate one or more indirect predictions, use the predictions to determine scores identifying a likelihood of a team accomplishing one or more goals, and output insights. From the direct team member goal probabilities, team success scores may be derived (including all or some subset of the defined goals) at the team member level, the team level (for one or more persons), an organization level (of one or more teams), and at a project level. While different weights may be attributable to different goals and/or team members, it may be effective to provide a weighted average, starting at the individual level and working towards the team level. While scored team factor groups may begin or be based on historical data related to an individual team member (such as at the start of a new project), these groups may be updated throughout a project or project phase, such as on a daily, weekly, bi-weekly, monthly, or quarterly basis through a peer rating process.

As one example, team factor group normalized values may be fed as inputs into analysis engine 107. The analysis engine 107 may then provides probabilities for team and project goals and the optimization engine 103 and the interface engine 109 may communicate to provide users with a display of data visualization at an individual person granularity or visibility level. The probabilities for goals at the project level may be calculated, such as by the indirect method discussed above. Additionally, the team success scores can be calculated in a preferred way. At an individual level, for instance, an individual's success score may be calculated by summing the individual goal probabilities provided by the analysis engine 107. Team scores may then be calculated as the weighted average of the individual scores for members of a particular team. Then, overall scores can be calculated for each organization involved in the project as a weighted average of the team success scores for the teams from the particular organization. Then project success scores can be calculated for the overall project as a weighted average of the organization scores for the organizations involved in the project. Accordingly, scores in normalized scales may be provided. Regardless of the scale used, the scores can then be used to predict the project and/or organization success, as defined by the selected project and/or organization goals, and reference can be made to them for initial team member selection, team formation, and improvement purposes.

In addition to providing predictions and feedback of information and insights to project, organization, and team managers, the method 200 may include providing automated training. That is, areas of improvement at the team, organization, and/or project level(s) can be identified, and respective training modules may then be automatically pushed (e.g., through email provided content or hyperlinks) to team, organization, and/or project leaders or managers to improve the team success scores (and/or the predictors and the alignment indicator scores) at those levels. While the goal is to improve the team success scores at those levels, since training is provided to individuals, the training is also likely to have an impact at the individual success score level. For instance, the system may generate representative graphics related to a particular initial (historical) or periodic peer rating review. The system is capable of identifying, for instance, one or more factor scores that need improving for a particular team or organization. For instance, the system may generate a histogram or other graphical representation of the three lowest scoring factors (contributing to a negative impact on the project success score) and the three highest scoring factors (contributing to a positive influence on the project success score). Depending on a review of the relative impact on the project success score of each factor (e.g., determined through regression analysis or other statistical methods), and the ease of implementation of improvement of at least the lowest performing factors, a ranking can be undertaken to prioritize automated training, such as by using graphical user interface elements to highlight particular factors. On a team or organization level, visibility can also be provided on a radar graph or other visualization to depict the organization or team success scores relative to other organization(s) or team(s).

The optimization engine 103 may therefore identify at least one characteristic of the team correlated with a modification to the determined likelihood of the team accomplishing the goal associated with the project. The modification may be a modification to increase the likelihood of the team accomplishing the goal. The modification may be a modification to decrease the likelihood of the team accomplishing the goal. The optimization engine 103 may generate a survey or other data collection process to provide to the members of the team having the at least one characteristic, the survey presenting at least one question associated with the performance of the team; send the survey to the members of the team according to a predetermined schedule (e.g., periodically and/or after completion of an action assigned to some or all of the team members in connection with a previous survey); may analyze at least one received response to the survey; and may determine a second modification to the likelihood of the team accomplishing the goal associated with the project, responsive to the analyzing of the at least one received response to the survey. The optimization engine 103 may send the schedule according to a schedule based on a plan for gamification of the experience. The optimization engine 103 may identify an action to assign to the members of the team having the at least one characteristic to improve the determined likelihood of the team accomplishing the goal associated with the project.

The optimization engine 103 may identify at least one characteristic of the team correlated with a modification to the determined likelihood of the team accomplishing the goal associated with the organization. The modification may be a modification to increase the likelihood of the team accomplishing the goal. The modification may be a modification to decrease the likelihood of the team accomplishing the goal. The optimization engine 103 may generate a survey to provide to the members of the team having the at least one characteristic, the survey presenting at least one question associated with the performance of the team; send the survey to the members of the team according to a predetermined schedule (e.g., periodically); may analyze at least one received response to the survey; and may determine a second modification to the likelihood of the team accomplishing the goal associated with the organization, responsive to the analyzing of the at least one received response to the survey. The optimization engine 103 may identify an action to assign to the members of the team having the at least one characteristic to improve the determined likelihood of the team accomplishing the goal associated with the organization. In some embodiments, automatically disseminated (e.g., upon completion of periodic peer review by all team members and/or upon the expiration of a length of time since last dissemination, or occurrence of a particular date/time) information or educational modules are substantively related to the areas that have been identified for team, organization, or project-wide improvement, leading to team, organization, or project-wide dissemination. Such educational modules and other recommended actions may eliminate challenges posed in attempting to communicate organization goals to a group referred to as “the frozen middle.” Although individuals at the highest levels of an organization may have a clear understanding of one or more organization goals, middle management and other individuals in the middle of the organizational hierarchy may or may not understand those goals or how to implement them or how to effect change and/or do not communicate them to the people below them, so the organization below the managers does not receive information relating to the organization goals. As will be understood by those of skill in the art, the frozen middle is an analogy suggesting a barrier (ice) to communication to the entire organization below the senior leadership level; by identifying actions that can increase the understanding of those individuals, the organization can increase the likelihood of success in achieving those goals.

Actions may further include recommendations for modification to hiring and/or on-boarding processes. The optimization engine 103 may access hiring data as part of accessing data associated with a team member. The optimization engine 103 may analyze data associated with a hiring process for a particular team member such as, without limitation, interviews, personality tests, references, etc., and use that analysis to identify a likelihood of success for a potential hire and/or make recommendations for actions for the potential hire to take before or after hiring to increase the likelihood of success.

By way of example, without limitation, the optimization engine 103 may determine that a team has a level of likelihood of accomplishing the goal that is below a threshold level of likelihood specified by a user and the optimization engine 103 may determine to generate one or more questions that would identify an area of weakness in the team; the optimization engine 103 may then generate an recommendation for one or more actions to take to remediate the area of weakness, such as, without limitation, tutorials, continuing education, professional development, or other actions that may strengthen one or more members of the team in an area related to a likelihood of accomplishing the goal. Similarly, the optimization engine may identify at least one characteristic of the team correlated with a modification to the determined likelihood of the team accomplishing the goal associated with the organization, determine that a team has a level of likelihood of accomplishing the goal that is below a threshold level of likelihood specified by a user and the optimization engine 103 may determine to generate one or more questions that would identify an area of weakness in the team; the optimization engine 103 may then generate an recommendation for one or more actions to take to remediate the area of weakness, such as, without limitation, tutorials, continuing education, professional development, or other actions that may strengthen one or more members of the team in an area related to a likelihood of accomplishing the goal. The optimization engine 103 may then direct the display of a subsequent survey to the team to determine whether the level of likelihood of the team accomplishing a goal (associated with either a project or an organization) has changed after the completion of the activity. The surveys may be presented as a form of “360 review” in which all team members are evaluated by all individuals who work with them or for them or to whom they report and are asked to evaluate those other team members in return. Therefore, because this data is being updated throughout a project, the system 100 may generate a visualization of relative feedback at an organizational or team level to identify any informational or educational disparities and to correct some or all of those disparities with automated information dissemination or educational materials or modules. The survey, while intended to be conducted in an automated fashion electronically, may administered in any manner, as will be understood by those of skill in the art.

In embodiments in which the system 100 conducts periodic surveys, the surveys may present questions for assessing strengths and weaknesses and other characteristics including, without limitation, key dynamics such as project information, Team Skills & Experience, Relationships, Trust & Values, Goals & Objectives, Roles & Responsibilities, DEI and ESG Alignment Categories; however, the surveys may also present questions for use in updating historical data stored by the data store 120.

The optimization engine 103 may determine a likelihood of retention of at least one of the plurality of members of the team by the at least one organization. The optimization engine 103 may determine a correlation between a likelihood of retention of the at least one of the plurality of members by the at least one organization and the determined likelihood of the team accomplishing the goal associated with the project. The optimization engine 103 may determine a correlation between a likelihood of retention of the at least one of the plurality of members by the at least one organization and the determined likelihood of the team accomplishing the goal associated with the at least one organization. The optimization engine 103 may provide an identification of how a likelihood of retention will impact an organizational goal or company outcome (including, without limitation, goals related to DEI or ESG or team success scores)

The optimization engine 103 may determine a correlation between a predicted budget and an actual amount needed available for spending based on team, project, organization, regulatory, and other factors. The optimization engine 103 may determine a correlation between a predicted schedule and an actual schedule based on team factors. The optimization engine 103 may determine a correlation between a likelihood of success in acquiring the ability to do a new project (e.g., succeeding in a request for proposal process) based on team factors, including combinations of available individuals to assign to a team and characteristics of both the organization and the available individuals.

The optimization engine 103 may determine a correlation between an impact of a characteristic of the project on the likelihood of meeting an organizational goal. For example, the location in which project work is to be done may impact the kind of team members that are available to work on the project, which may impact the organization's goals for DEI. Similarly, the type of company, materials used, project type, other team members, and other factors relating to the project may impact the kind of team members that are available to work on the project, which may impact the organization's goals for DEI.

The method 200 includes modifying, by the optimization engine, a user interface displaying a visualization of the determinations of the optimization engine (214). The optimization engine 103 may display visualizations including, for example, a percentage of completion of improvement-related tasks. The optimization engine 103 may display any recommendations generated by the optimization engine 103.

Upon having displayed the visualization, the optimization engine 103 may direct the display of a user interface, e.g., via the interface generation engine 109, of user interface elements that allow users of the system 100 to request visualization of additional data sets. The optimization engine 103 may direct the display of a user interface, e.g., via the interface generation engine 109, of user interface elements that allow users of the system 100 to request and view a model of scenarios in which different data points are modified—for example, to model a scenario in which a first team member is removed from a project and a second team member replaces the first team member and to display the likelihood of success of the modified team along various metrics described above.

Therefore the method 200 may include receiving, by the optimization engine 103, via the user interface, user input instructing the optimization engine 103 to modify an identification of the members of the team to replace one member of the team with a second member of the at least one organization; modifying, by the optimization engine 103, the identification responsive to the user input; analyzing, by the optimization engine 103, data relating to at least one characteristic of the second member; determining, by the optimization engine 103, a level of contribution of the second member to the goal associated with the at least one organization; determining, by the optimization engine 103, a level of contribution of the second member to the goal associated with the project; determining, by the optimization engine 103, a likelihood of the modified team accomplishing the goal associated with the project; and modifying, by the optimization engine 103, a user interface displaying a visualization of the determinations of the optimization engine 103 when the team includes the second member instead of the first member.

Therefore, for initial team member selection or team member changes during a project, the system 100 may provide comparison capabilities between a plurality of optional teams to help project, organization, or team managers select appropriate team members to provide a desired likelihood of success for a project. Comparisons on effect of team member selections or alterations may be graphically represented to assist decision makers. The optimization engine 103 may generate one or more insights upon completion of the analyses and determinations described above, access to which can be controlled through conventional authentication techniques, including username/password combinations (optionally including two-factor authentication), or even biometric authentication. For instance, an individual team member may have access to individual scores while a team leader may have access to their individual data, as any individual team member has, in addition to team data. A project manager or leader preferably has access to all levels of information within their organization and teams they run, further including project data, team data, and organization data, including without limitation, data identifying areas of strength, areas for improvement, impact of team and/or organization scores on improvement of scores at the team, organization, and project level. These insights may be provided graphically at each level to the appropriate individuals through a graphical display.

The method 200 may include execution of functionality to allow the optimization engine 103 to automatically generate one or more models of hypothetical situations and to provide users with visualizations of possible optimizations along various metrics, without requiring specific user input requesting the generation of the additional models.

Therefore the method 200 may include analyzing, by the optimization engine, data relating to at least one characteristic of a second member of the at least one organization; modifying, by the optimization engine, an identification of the members of the team to replace one member of the team with the second member of the at least one organization; determining, by the optimization engine, a level of contribution of the second member to the goal associated with the at least one organization; determining, by the optimization engine, a level of contribution of the second member to the goal associated with the project; determining, by the optimization engine, a likelihood of the modified team accomplishing the goal associated with the project; and modifying, by the optimization engine, a user interface to display a visualization of the determinations of the optimization engine when the team includes the second member instead of the first member and to include a recommendation to modify the team to include the second member.

Although described above in connection with a single team and at least one organization, the methods and systems described herein may apply when there are team members available from multiple organizations for work on a single project and when one or more organizations seek to review success scores and recommendations across a portfolio of projects. The methods and systems described herein may further apply to use cases which benefit from the optimization engine 103 generating a likelihood of success based on a leadership team for an organization; the optimization engine 103 may do so not just for one company but across companies. By way of example, and without limitation, such a use case might involve a private equity user who is determining whether to invest in a company based on the likelihood of success the company will have in accomplishing one or more goals. Similarly, users may request an indication of a level of investability in one or more companies based on the analyses provided by the optimization engine and data provided by the users. The methods and systems described herein may provide functionality for determining a level of likelihood of achieving, by a team that is its own corporate entity, a goal associated with a project and/or a goal associated with an investing organization (e.g., investors in the corporate entity) and/or a goal associated with the project. Projects as described above may, as will be understood by those of skill in the art, include sub-projects performed by the same or different composition of team members. However, projects as described herein may refer not only to groups of tasks to be completed in order to reach a specific outcome in a conventional project management sense but also the specific outcomes may include outcomes to be achieved by any type of entity including, without limitation, departments, units, business units/lines of business, subsidiaries, and entire companies. Similarly goals associated with organizations may include, without limitations, goals to be accomplished by any type of entity including, without limitation, departments, units, business units/lines of business, subsidiaries, and entire companies. The functionality described herein for identifying correlations between characteristics of team members and likelihoods of success of those teams in achieving both project goals and organizational goals include not just the organizational goals associated with DEI/ESG, which are included as examples herein, but also goals such as likelihood to achieve profitability, likelihood of returning an investment of a certain amount (e.g., to any stakeholders including without limitation, investment by company executives, investment by private investors, investment in the form of acquisition by other organizations, loans made by public or private entities, and so on), likelihood to integrate successfully with other organizations, and so on.

Furthermore, although described above in terms of a team member assigned to or available for assignment to a project, the methods and systems described herein may apply when a team includes an informal member or a stakeholder not contractually assigned to the project (including community representatives, regulatory officials, etc.).

Referring now to FIG. 3, in brief overview, a block diagram depicts one embodiment of a method 300 for generating performance optimization recommendations and modifying a user interface displaying at least one visualization of performance-related data. The method 300 includes accessing, by an optimization engine, data identifying a goal associated with a project (302). The method 300 includes accessing, by the optimization engine, data identifying a goal associated with at least one organization having at least one member available for assignment to the project (304). The method 300 includes analyzing, by the optimization engine, data relating to at least one characteristic of the at least one member (306). The method 300 includes identifying a proposed team including a plurality of members to assign to the project (308). The method 300 includes determining, by the optimization engine, a level of contribution of each of the plurality of members of the proposed team to the goal associated with the at least one organization (310). The method 300 includes determining, by the optimization engine, a level of contribution of each of the plurality of members of the proposed team to the goal associated with the project (312). The method 300 includes determining, by the optimization engine, a likelihood of the team accomplishing the goal associated with the project (314). The method 300 includes modifying, by the optimization engine, a user interface displaying a visualization of the determinations of the optimization engine and a recommendation to assign the proposed team to the project (316).

Referring now to FIG. 3, in greater detail and in connection with FIGS. 1-2, the method 300 includes accessing, by an optimization engine, data identifying a goal associated with a project (302). The optimization engine 103 may access the data as described above in connection with FIG. 2.

The method 300 includes accessing, by the optimization engine, data identifying a goal associated with at least one organization having at least one member available for assignment to the project (304). The optimization engine 103 may access the data as described above in connection with FIG. 2.

The method 300 includes analyzing, by the optimization engine, data relating to at least one characteristic of the at least one member (306). The optimization engine 103 may analyze the at least one characteristic as described above in connection with FIG. 2.

The method 300 includes identifying a proposed team including a plurality of members to assign to the project (308).

The method 300 includes determining, by the optimization engine, a level of contribution of each of the plurality of members of the proposed team to the goal associated with the at least one organization (310). The optimization engine 103 may make the determination as described above in connection with FIG. 2.

The method 300 includes determining, by the optimization engine, a level of contribution of each of the plurality of members of the proposed team to the goal associated with the project (312). The optimization engine 103 may make the determination as described above in connection with FIG. 2.

The method 300 includes determining, by the optimization engine, a likelihood of the team accomplishing the goal associated with the project (314). The optimization engine 103 may make the determination as described above in connection with FIG. 2.

The method 300 includes modifying, by the optimization engine, a user interface displaying a visualization of the determinations of the optimization engine and a recommendation to assign the proposed team to the project (316). The optimization engine 103 may direct the modification of the user interface 111 as described above in connection with FIG. 2.

As will be understood by those of skill in the art, although described above in connection with correlation between project goals and organizational goals with other correlations possible, the methods and systems described herein may be used to correlate and make recommendations for improvement of a group of individuals' (e.g., a team) likelihood of success on a project as correlated with either organizational goals or goals associated with the team or goals associated with both or any combination thereof.

Therefore, the methods and systems described herein may provide functionality for accessing, by an optimization engine, data identifying a goal associated with a project assigned to a team associated with at least one organization; accessing, by the optimization engine, data identifying a goal associated with the team; analyzing, by the optimization engine, data relating to at least one characteristic of each of a plurality of members of the team; determining, by the optimization engine, a level of contribution of each of the plurality of members of the team to the goal associated with the team; determining, by the optimization engine, a level of contribution of each of the plurality of members of the team to the goal associated with the project; determining, by the optimization engine, a likelihood of the team accomplishing the goal associated with the project; and modifying, by the optimization engine, a user interface displaying a visualization of the determinations of the optimization engine. Similarly, the methods and systems described herein may provide functionality for accessing, by an optimization engine, data identifying a goal associated with a project assigned to a team associated with at least one organization; accessing, by the optimization engine, data identifying a goal associated with the team; accessing, by the optimization engine, data identifying a goal associated with the team; analyzing, by the optimization engine, data relating to at least one characteristic of each of a plurality of members of the team; determining, by the optimization engine, a level of contribution of each of the plurality of members of the team to the goal associated with the team; determining, by the optimization engine, a level of contribution of each of the plurality of members of the team to the goal associated with the at least one organization; determining, by the optimization engine, a level of contribution of each of the plurality of members of the team to the goal associated with the project; determining, by the optimization engine, a likelihood of the team accomplishing the goal associated with the project; and modifying, by the optimization engine, a user interface displaying a visualization of the determinations of the optimization engine. The method may include determining the likelihood of the team accomplishing the goal associated with the team. The method may include determining the likelihood of the team accomplishing the goal associated with the organization.

In some embodiments, a method may include training an artificial intelligence model using at least one of historical project data and historical personnel data; before a start of a new project, obtaining new project definition data, including at least one project goal; obtaining new personnel data related to a team of one or more persons; providing the new project definition data and new personnel data to the model; receiving from the model a probability related to the likelihood that the project goal will be met if the team attempts to achieve the project goal; and calculating a team success score based on the probability. In such a method there may be a plurality of project or organization goals. In such a method there may be a binary project or organization goal instead of or in addition to a goal where success is measured as a percentage or other metric.

As indicated above, data may be collected that is related to individuals; such data may be referred to as team factors. Data collected that is related to projects may be referred to as project factors. Data collected that is related to organizations may be referred to as organizational factors. Data may be scored or selected from a limited list. Factors may be grouped into relational groups and represented by an averaged or otherwise normalized value to provide a factor score. Factors may be treated with the same importance, or selectively weighted through system settings. The team factors may be grouped into one or more factor categories. In some embodiments, open-ended (e.g., fill-in-the-blank) information requests may be used for information purposes and may or may not be scored or used in analysis, depending on whether the optimization engine 103 is configured to use such data in its analyses. Data may be imported from a third-party data store and formatted for use by the optimization engine 103.

Byway of example and without limitation, in an embodiment in which the system 100 directly requests answers to questions as part of a data-gathering process, questions may be formed as shown in the groupings of questions following sets of questions shown below. The following examples are, however, provided only for illustrative purposes—for instance, when an example indicates that a user may be asked to score a response based on a scale of 1-5, the scale may be any range of numbers or other metric for scaling responses.

Questions relating to Team Member Information (TMI) may include, without limitation, questions such as:
Please specify the number of team members you will provide information on for this project. Please include yourself as one of the team members.
For each team member (including the team manager) please answer the following:
   Name of reviewer, team members
      Open-text box
   Name of company person worked for during project
      Open-text box
Project role (select one)
   Project Management
   Site Superintendent/Foreman
   Construction Engineering
   Construction Management
   Asset Management
   Facility Design & Engineering
   Architecture
   Planning
   Operations Engineering
   Operations/Facilities Management
   Property Management
   Real-Estate Development
   Real-Estate Portfolio Management
   General Labour
   Scheduling & Estimating
   Inspection
   Surveyor
   Equipment Operator
   HSE
   Legal
   Procurement
   Commissioning
   Administrative
   Supply Chain Management
   Commercial Management
   Quality Management
   Project Controls
   Regional/Business Executive
   Project Executive
Time Devoted to this project (select one)
   <25%
   25 to 50%
   50% to 70%
   76% to 90%
   >90%
Age (select one)
   18-29
   30-39
   40-49
   50-59
   Over 59
Daily commute time (select one)
   Less than 15 minutes
   Between 15 and 45 minutes
   Between 45 mins and 90 minutes
   More than 90 minutes
Ethnicity (select one)
   Asian
   Black or African American
   Caucasian
   Hispanic/Latino
   Native American
   Other—please specify
Experience related to this project (select one)
   0-5 years
   6-10 years
   11-15 years
   More than 15 years
Gender (select one)
   Male
   Female
   Non-binary
   Other Not Listed
   Prefer Not to Answer
Where resided? (select all that apply)
   Asia
   Australia/New Zealand
   Canada
   Africa
   Europe
   Latin America (LATAM)
   United States
   South America
   Middle East
   Open-text box
Organization worked for (select one)
   Owner-side
   Supplier-side
   Sub-supplier
Primary workplace
   Office
   On-site
   Remote working
   Hybrid working

Questions may include questions about whether a workspace is conducive to a team member doing work without disruption.

Questions may include questions about project-related factors.

As another example and without limitation, in an embodiment in which the system 100 directly requests answers to questions as part of a data-gathering process, questions relating to team leadership may include, without limitation, questions such as: Please rate based on the 5-point scale where: 1=strongly disagree, 2=somewhat disagree, 3=neither disagree nor agree, 4=somewhat agree, 5=strongly agree—whether you
Cared about continual improvement
Collaborated by sharing ideas to ensure tasks are performed effectively
Comfortable giving negative feedback
Comfortable receiving negative feedback
Comfortable giving positive feedback
Comfortable receiving positive feedback
Comfortable with high-risk situations
Comfortable with concept of shared leadership
Excellent listener
Exercised good judgement in decision-making
Felt personally accountable to do what they say they will do
Helped when someone has difficulties performing tasks
High level of self-awareness
Highly committed to helping develop the people around them
Held themselves to the highest ethical standards without supervision
Provided input/thoughts throughout project
Recognized when incorrect and accepts responsibility for mistakes
Spent time to clarify team expectations

As another example and without limitation, in an embodiment in which the system 100 directly requests answers to questions as part of a data-gathering process, questions relating to team relationships may include, without limitation, questions such as: Please rate based on the 5-point scale where: 1=strongly disagree, 2=somewhat disagree, 3=neither disagree nor agree, 4=somewhat agree, 5=strongly agree—whether you
Other Team Member Peer Review Conducted (Yes/No)
Always looked out for the team
Appropriate level of planning and executing
Carried fair share of the work
Felt like they are part of the team
Got the majority of their work done on time and on budget
Handled team conflict well
High motivation and interest in the team and project
Was highly empathetic
Was generally happy
Made decisions with involvement of team members
Managed their stress and mental health
Preferred to work by themselves
External factors impacted this person's performance during the project
Strong agent of change
Strong desire to learn and implement lessons learned
Strong sense of curiosity
Strong work ethic while avoiding burnout
Strongly supports diversity, equity, and inclusion

As another example and without limitation, in an embodiment in which the system 100 directly requests answers to questions as part of a data-gathering process, questions relating to team trust and/or values may include, without limitation, questions such as: Please rate based on the 5-point scale where: 1=strongly disagree, 2=somewhat disagree, 3=neither disagree nor agree, 4=somewhat agree, 5=strongly agree—whether you
Adhered strongly to the specified core values
Believed trust is an important component in teams
Felt the work is making a difference
Known for being trustworthy
Showed appreciation for team members
Treated others with respect
Trusted teammates in making decisions for the team
Trusted the team

As another example and without limitation, in an embodiment in which the system 100 directly requests answers to questions as part of a data-gathering process, questions relating to team communication may include, without limitation, questions such as: Please rate based on the 5-point scale where: 1=strongly disagree, 2=somewhat disagree, 3=neither disagree nor agree, 4=somewhat agree, 5=strongly agree whether you
Cared about the welfare of teammates
Exercised effective conflict management
Involved team members in decisions
Worked constructively on issues until they are resolved

As another example and without limitation, in an embodiment in which the system 100 directly requests answers to questions as part of a data-gathering process, questions relating to team goals and objectives may include, without limitation, questions such as: Please rate based on the 5-point scale where: 1=strongly disagree, 2=somewhat disagree, 3=neither disagree nor agree, 4=somewhat agree, 5=strongly agree—whether you
Understood team's goals and objectives
Agreed with team's goals and objectives
Committed to achieving team's goals and objectives
Always thought about actions' impact on customers
Driven to deliver high-quality work
Committed to environmental, social, and corporate governance (ESG) goals
Higher purpose (e.g., equal rights) for the team is important
Strong drive to deliver work on schedule and budget
Works safely without supervision and is committed to a safe work environment

As another example and without limitation, in an embodiment in which the system 100 directly requests answers to questions as part of a data-gathering process, questions relating to team roles and responsibilities may include, without limitation, questions such as: Please rate based on the 5-point scale where: 1=strongly disagree, 2=somewhat disagree, 3=neither disagree nor agree, 4=somewhat agree, 5=strongly agree—whether you
Understood their assigned responsibilities
Agreed with assigned roles and responsibilities
Clear on their role in relation to the team as a whole
Completed similar projects prior to this project
Education level? (drop down of options)
   Less than high school
   High school
   Bachelor's degree
   Master's degree
   PhD
Had the appropriate proficiency with tools/software for their role on the project
Had the appropriate project-specific chartership & licensing for their role in the project—(note to programmer—add “Not Applicable (N/A)
Had the correct educational level for their role in the project
Had the correct technical skills for their role in this project
Had the necessary expertise to perform the tasks
Had the necessary skills to perform the tasks
Please type in charterships and licenses (type “N/A” if none)
   Open-text box
Was willing to help with unforeseen problems that need immediate attention
Was willing to take initiative for unassigned tasks

Likewise, the project information and factors may be grouped into factor categories, as follows:

### Project Info

Please enter the name of your project
   Open text box
What sector was the project part of?
   Energy
   Materials
   Industrials
   Consumer Discretionary
   Consumer Staples
   Health Care
   Financials
   Information Technology
   Communication Services
   Utilities
   Real Estate
Type of contract? (drop down of options)
   Design, Bid, Build
   EPC
   Planning
   Architecture/Engineering
   Owner's Rep
   CM at Risk
   Other—please specify

Please rate the following based on the 5-point scale where: 1=strongly disagree, 2=somewhat disagree, 3=neither disagree nor agree, 4=somewhat agree, 5=strongly agree—whether
Clear contractual arrangements were in place before work started
Conflicts of interest were identified and addressed before project start
High project importance to business
High urgency on project completion
Project fully funded before project start
Project implementation was not disruptive to facility operations

As another example and without limitation, in an embodiment in which the system 100 directly requests answers to questions as part of a data-gathering process, questions relating to project cost may include, without limitation, questions such as:
The actual overall cost of the project (drop down of options)
   Less than $100,000
   $100,000-$1 million
   $1 million-$10 million
   $10 million-$50 million
   $50 million-$200 million
   More than $200 million
The budgeted cost of the project (including contingency) (drop down of options)
   Less than $100,000
   $100,000-$1 million
   $1 million-$10 million
   $10 million-$50 million
   $50 million-$200 million
   More than $200 million

Questions may also include questions such as: Please rate the following based on the 5-point scale where: 1=strongly disagree, 2=somewhat disagree, 3=neither disagree nor agree, 4=somewhat agree, 5=strongly agree whether you thought
Overall project cost was managed efficiently
Project costs were continuously monitored
Project was completed within budget (Yes/No) (possible goal “P-cost”)
Team sought alternative solutions with less emphasis on cost

As another example and without limitation, in an embodiment in which the system 100 directly requests answers to questions as part of a data-gathering process, questions relating to project scheduling may include, without limitation, questions such as:
Planned duration of the project (drop down of options)
   0-6 months
   7-12 months
   13-18 months
   19-24 months
   More than 24 months
Actual duration of the overall project (drop down of options)
   0-6 months
   7-12 months
   13-18 months
   19-24 months
   More than 24 months

Questions may include questions such as Please rate the following based on the 5-point scale where: 1=strongly disagree, 2=somewhat disagree, 3=neither disagree nor agree, 4=somewhat agree, 5=strongly agree whether you thought
The master schedule was up to date
The team established a sense of urgency and adjustments were promptly made to maintain or improve the schedule
Critical milestones were well-monitored
Reports and project documentation were prepared within the time given
The project was completed on time (Yes/No) (possible goal “P-sched”)
Unforeseen physical and weather conditions were considered in project schedule

As another example and without limitation, in an embodiment in which the system 100 directly requests answers to questions as part of a data-gathering process, questions relating to project phases and tasks may include, without limitation, questions such as: Please rate based on the 5-point scale where: 1=strongly disagree, 2=somewhat disagree, 3=neither disagree nor agree, 4=somewhat agree, 5=strongly agree—whether you thought
Activities during the project were inspected to ensure quality work
Leaders were satisfied with the time taken to issue design information
Procedures adopted by the project team ensured that the level of quality remained constant throughout the life of the project
Project was completed correctly
Project had a high-quality design
Project planning had been achieved correctly
Project Management Plan, WBS developed, reviewed, and implemented
The correct project management and technical products & tools were available and used
The correct reviews & approvals processes were available and used.

As another example and without limitation, in an embodiment in which the system 100 directly requests answers to questions as part of a data-gathering process, questions relating to project team management may include, without limitation, questions such as: Please rate based on the 5-point scale where: 1=strongly disagree, 2=somewhat disagree, 3=neither disagree nor agree, 4=somewhat agree, 5=strongly agree—whether you thought
Effective conflict management was exercised within the team
Good decisions were always made within the team regarding project matters
Professional and skilled people were hired for the project
Project team communicated in an effective manner
Project team members demonstrated expertise necessary for the project
Team members felt safe to take risks around their team members
Team cared about the welfare of their teammates
Decisions were made with the involvement of all team members
Good service from the team was demonstrated during the project
Project team responded quickly to customer needs with professional service
Team demonstrated good technical ability on the project
Team had a friendly atmosphere and trust
Team worked constructively on issues arise until they were resolved
Teammates cared about each other
The team believed trust was an important component
Would like to work together again with the team in future projects
All key team roles were filled prior to project start
There were specified core values for this team (Yes/No)
This was a successful team. (Yes/No) (possible goal “T-success”)

As another example and without limitation, in an embodiment in which the system 100 directly requests answers to questions as part of a data-gathering process, questions relating to owner satisfaction may include, without limitation, questions such as: Please rate based on the 5-point scale where: 1=strongly disagree, 2=somewhat disagree, 3=neither disagree nor agree, 4=somewhat agree, 5=strongly agree—whether you thought
Completed project met the quality standard specified during earlier phases
Owner was satisfied with the final product of the project
Project site was kept clean and organized
Project team exercised an effective documentation system
Project team successfully achieved the project objectives—this was a successful project. (Yes/No) (possible goal “P-success”)

Questions relating to project change management may include questions such as:
The number of change orders that were submitted within the project (drop down of options)
   None
   1-5
   6-10
   11-15
   More than 15
The most common cause of change orders that were submitted (drop down of options)
   Inadequate project objectives
   Design errors and omissions
   Conflicts between contract documents
   Ambiguous design details
   Lack of contractor's involvement in design
   Inaccurate specifications in the original designs or contract
   Unforeseen conditions at the job site, such as obstructions that could not be planned for
   Workers or materials that do not arrive or come late to the site
   Faulty budgets and schedules
   Other

Please rate the following based on the 5-point scale where: 1=strongly disagree, 2=somewhat disagree, 3=neither disagree nor agree, 4=somewhat agree, 5=strongly agree whether you thought
A defined change control system was used for the project
Change control system was well-managed by the project team
Decisions to rework were based on cost not value of work
Project had no deficiencies
Project was flexible to accommodate the owner-requested changes at any time

As another example and without limitation, in an embodiment in which the system 100 directly requests answers to questions as part of a data-gathering process, questions relating to project safety may include, without limitation, questions such as: Please rate based on the 5-point scale where: 1=strongly disagree, 2=somewhat disagree, 3=neither disagree nor agree, 4=somewhat agree, 5=strongly agree—whether you thought there were
Near misses
OSHA recordable
First-aid cases
Workers' compensation cases
Lost workdays
Not applicable
Other—please specify

Questions may include requests regarding whether
Project team reported accident statistics on a regular basis
Exceptional efforts were made to establish effective safety procedures
Owner established specific safety goals for the team performing this project
Project leader established specific safety goals for the team performing this project
Project safety inspections were conducted throughout the project
Project safety inspections were well—managed
Safety was clearly a priority in this project
Safety record keeping and reporting were well-managed and documented
This was a safe project (Yes/No) (possible goal “P-safe”).

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIGS. 2 and 3.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

Although terms such as “optimize” and “optimal” may be used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C #, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Referring now to FIGS. 4A, 4B, and 4C, block diagrams depict additional detail regarding computing devices that may be modified to execute novel, non-obvious functionality for implementing the methods and systems described above.

Referring now to FIG. 4A, an embodiment of a network environment is depicted. In brief overview, the network environment comprises one or more clients 402a-302n (also generally referred to as local machine(s) 402, client(s) 402, client node(s) 402, client machine(s) 402, client computer(s) 402, client device(s) 402, computing device(s) 402, endpoint(s) 402, or endpoint node(s) 402) in communication with one or more remote machines 406a-406n (also generally referred to as server(s) 406 or computing device(s) 406) via one or more networks 404.

Although FIG. 4A shows a network 404 between the clients 402 and the remote machines 406, the clients 402 and the remote machines 406 may be on the same network 404. The network 404 can be a local area network (LAN), such as a company Intranet, a metropolitan area network (MAN), or a wide area network (WAN), such as the Internet or the World Wide Web. In some embodiments, there are multiple networks 404 between the clients 402 and the remote machines 406. In one of these embodiments, a network 404′ (not shown) may be a private network and a network 404 may be a public network. In another of these embodiments, a network 404 may be a private network and a network 404′ a public network. In still another embodiment, networks 404 and 404′ may both be private networks. In yet another embodiment, networks 404 and 404′ may both be public networks.

The network 404 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, a wireline network, an Ethernet, a virtual private network (VPN), a software-defined network (SDN), a network within the cloud such as AWS VPC (Virtual Private Cloud) network or Azure Virtual Network (VNet), and a RDMA (Remote Direct Memory Access) network. In some embodiments, the network 404 may comprise a wireless link, such as an infrared channel or satellite band. The topology of the network 404 may be a bus, star, or ring network topology. The network 404 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 402 and a remote machine 406 (referred to generally as computing devices 400 or as machines 400) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 402 may execute, operate or otherwise provide an application, which can be any type and/or form of software, program, or executable instructions, including, without limitation, any type and/or form of web browser, web-based client, client-server application, an ActiveX control, a JAVA applet, a webserver, a database, an HPC (high performance computing) application, a data processing application, or any other type and/or form of executable instructions capable of executing on client 402.

In one embodiment, a computing device 406 provides functionality of a web server. The web server may be any type of web server, including web servers that are open-source web servers, web servers that execute proprietary software, and cloud-based web servers where a third party hosts the hardware executing the functionality of the web server. In some embodiments, a web server 406 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, WA, the ORACLE IPLANET web server products provided by Oracle Corporation of Redwood Shores, CA, or the ORACLE WEBLOGIC products provided by Oracle Corporation of Redwood Shores, CA.

In some embodiments, the system may include multiple, logically-grouped remote machines 406. In one of these embodiments, the logical group of remote machines may be referred to as a server farm 438. In another of these embodiments, the server farm 438 may be administered as a single entity.

FIGS. 4B and 4C depict block diagrams of a computing device 400 useful for practicing an embodiment of the client 402 or a remote machine 406. As shown in FIGS. 4B and 4C, each computing device 400 includes a central processing unit 421, and a main memory unit 422. As shown in FIG. 4B, a computing device 400 may include a storage device 428, an installation device 416, a network interface 418, an I/O controller 423, display devices 424a-n, a keyboard 426, a pointing device 427, such as a mouse, and one or more other I/O devices 430a-n. The storage device 428 may include, without limitation, an operating system and software. As shown in FIG. 4C, each computing device 400 may also include additional optional elements, such as a memory port 403, a bridge 470, one or more input/output devices 430a-n (generally referred to using reference numeral 430), and a cache memory 440 in communication with the central processing unit 421.

The central processing unit 421 is any logic circuitry that responds to and processes instructions fetched from the main memory unit 422. In many embodiments, the central processing unit 421 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include RISC-V processors, SPARC processors, ARM processors, processors used to build UNIX/LINUX “white” boxes, and processors for mobile devices. The computing device 400 may be based on any of these processors, or any other processor capable of operating as described herein.

Main memory unit 422 may be one or more memory chips capable of storing data and allowing any storage location to be directly accessed by the microprocessor 421. The main memory 422 may be based on any available memory chips capable of operating as described herein. In the embodiment shown in FIG. 4B, the processor 421 communicates with main memory 422 via a system bus 450. FIG. 4C depicts an embodiment of a computing device 400 in which the processor communicates directly with main memory 422 via a memory port 403. FIG. 3C also depicts an embodiment in which the main processor 421 communicates directly with cache memory 440 via a secondary bus, sometimes referred to as a backside bus. In other embodiments, the main processor 421 communicates with cache memory 440 using the system bus 450.

In the embodiment shown in FIG. 4B, the processor 421 communicates with various I/O devices 430 via a local system bus 450. Various buses may be used to connect the central processing unit 421 to any of the I/O devices 430, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 424, the processor 421 may use an Advanced Graphics Port (AGP) to communicate with the display 424. FIG. 4C depicts an embodiment of a computing device 400 in which the main processor 421 also communicates directly with an I/O device 430b via, for example, HYPERTRANSPORT, RAPIDIO, or INFINIBAND communications technology.

One or more of a wide variety of I/O devices 430a-n may be present in or connected to the computing device 400, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 423 as shown in FIG. 4B. Furthermore, an I/O device may also provide storage and/or an installation medium 416 for the computing device 400. In some embodiments, the computing device 400 may provide USB connections (not shown) to receive handheld USB storage devices such as the USB Flash Drive line of devices manufactured by Twintech Industry, Inc. of Los Alamitos, CA.

Referring still to FIG. 4B, the computing device 400 may support any suitable installation device 416, such as hardware for receiving and interacting with removable storage; e.g., disk drives of any type, CD drives of any type, DVD drives, tape drives of various formats, USB devices, external hard drives, or any other device suitable for installing software and programs. In some embodiments, the computing device 400 may provide functionality for installing software over a network 404. The computing device 400 may further comprise a storage device, such as one or more hard disk drives or redundant arrays of independent disks, for storing an operating system and other software. Alternatively, the computing device 300 may rely on memory chips for storage instead of hard disks.

Furthermore, the computing device 400 may include a network interface 418 to interface to the network 404 through a variety of connections including, but not limited to, standard telephone lines, LAN or WAN links (e.g., 802.11, T1, T3, 56 kb, X.25, SNA, DECNET, RDMA), broadband connections (e.g., ISDN, Frame Relay, ATM, Gigabit Ethernet, Ethernet-over-SONET), wireless connections, virtual private network (VPN) connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 400 communicates with other computing devices 400′ via any type and/or form of gateway or tunneling protocol such as GRE, VXLAN, IPIP, SIT, ip6tnl, VTI and VTI6, IP6GRE, FOU, GUE, GENEVE, ERSPAN, Secure Socket Layer (SSL) or Transport Layer Security (TLS). The network interface 418 may comprise a built-in network adapter, network interface card, PCMCIA network card, card bus network adapter, wireless network adapter, USB network adapter, modem, or any other device suitable for interfacing the computing device 400 to any type of network capable of communication and performing the operations described herein.

In further embodiments, an I/O device 430 may be a bridge between the system bus 450 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 400 of the sort depicted in FIGS. 4B and 4C typically operates under the control of operating systems, which control scheduling of tasks and access to system resources. The computing device 400 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 7, WINDOWS 8, WINDOWS VISTA, WINDOWS 10, and WINDOWS 11 all of which are manufactured by Microsoft Corporation of Redmond, WA; MAC OS manufactured by Apple Inc. of Cupertino, CA; OS/2 manufactured by International Business Machines of Armonk, NY; Red Hat Enterprise Linux, a Linux-variant operating system distributed by Red Hat, Inc., of Raleigh, NC; Ubuntu, a freely-available operating system distributed by Canonical Ltd. of London, England; CentOS, a freely-available operating system distributed by the centos.org community; SUSE Linux, a freely-available operating system distributed by SUSE, or any type and/or form of a Unix operating system, among others.

In some embodiments, an IT infrastructure may extend from a first network—such as a network owned and managed by an individual or an enterprise—into a second network, which may be owned or managed by a separate entity than the entity owning or managing the first network. Resources provided by the second network may be said to be “in a cloud.” Cloud-resident elements may include, without limitation, storage devices, servers, databases, computing environments (including virtual machines, servers, and desktops), and applications. For example, the IT network may use a remotely located data center to store servers (including, for example, application servers, file servers, databases, and backup servers), routers, switches, and telecommunications equipment. The data center may be owned and managed by the IT network or a third-party service provider (including for example, a cloud services and hosting infrastructure provider) may provide access to a separate data center.

In some embodiments, one or more networks providing computing infrastructure on behalf of customers is referred to a cloud. In one of these embodiments, a system in which users of a first network access at least a second network including a pool of abstracted, scalable, and managed computing resources capable of hosting resources may be referred to as a cloud computing environment. In another of these embodiments, resources may include, without limitation, virtualization technology, data center resources, applications, and management tools. In some embodiments, Internet-based applications (which may be provided via a “software-as-a-service” model) may be referred to as cloud-based resources. In other embodiments, networks that provide users with computing resources, such as remote servers, virtual machines, or blades on blade servers, may be referred to as compute clouds or “infrastructure-as-a-service” providers. In still other embodiments, networks that provide storage resources, such as storage area networks, may be referred to as storage clouds. In further embodiments, a resource may be cached in a local network and stored in a cloud.

In some embodiments, some or all of a plurality of remote machines 1o6 may be leased or rented from third-party companies such as, by way of example and without limitation, Amazon Web Services LLC of Seattle, WA; Rackspace US, Inc. of San Antonio, TX; Microsoft Corporation of Redmond, WA; and Google Inc. of Mountain View, CA. In other embodiments, all the machines 1o6 are owned and managed by third-party companies including, without limitation, Amazon Web Services LLC, Rackspace US, Inc., Microsoft, and Google. Other third-party provided hosted services include AZURE App Service Engine and AZURE Functions. The methods and systems described herein may leverage in programming language frameworks, such as Bootstrap, React, or Angular.

Having described certain embodiments of methods and systems for generating performance optimization recommendations and related data visualization, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for generating performance optimization recommendations and modifying a user interface displaying at least one visualization of performance-related data, the method comprising:
accessing, by an optimization engine, data identifying a goal associated with a project assigned to a team associated with at least one organization;
accessing, by the optimization engine, data identifying a goal associated with the at least one organization;
analyzing, by the optimization engine, data relating to at least one characteristic of each of a plurality of members of the team;
determining, by the optimization engine, a level of contribution of each of the plurality of members of the team to the goal associated with the at least one organization;
determining, by the optimization engine, a level of contribution of each of the plurality of members of the team to the goal associated with the project;
determining, by the optimization engine, a likelihood of the team accomplishing the goal associated with the project; and
modifying, by the optimization engine, a user interface displaying a visualization of the determinations of the optimization engine.

2. The method of claim 1, wherein the goal associated with the project relates to a metric of success.

3. The method of claim 1, wherein the goal associated with the at least one organization relates to a human resources goal.

4. The method of claim 1, wherein the goal associated with the at least one organization relates to a corporate governance goal.

5. The method of claim 1 further comprising determining, by the optimization engine, a likelihood of retention of at least one of the plurality of members of the team by the at least one organization.

6. The method of claim 5 further comprising determining, by the optimization engine, a correlation between a likelihood of retention of the at least one of the plurality of members by the at least one organization and the determined likelihood of the team accomplishing the goal associated with the project.

7. The method of claim 5 further comprising determining, by the optimization engine, a correlation between a likelihood of retention of the at least one of the plurality of members by the at least one organization and the determined likelihood of the team accomplishing the goal associated with the at least one organization.

8. The method of claim 1 further comprising identifying, by the optimization engine, at least one characteristic of the team correlated with a modification to the determined likelihood of the team accomplishing the goal associated with the project.

9. The method of claim 8 further comprising:
generating, by the optimization engine, a survey to provide to the members of the team having the at least one characteristic, the survey presenting at least one question associated with the performance of the team;
sending, by the optimization engine, the survey to the members of the team according to a predetermined schedule;
analyzing, by the optimization engine, at least one received response to the survey; and
determining, by the optimization engine, a second modification to the likelihood of the team accomplishing the goal associated with the project, responsive to the analyzing of the at least one received response to the survey.

10. The method of claim 8 further comprising identifying, by the optimization engine, an action to assign to the members of the team having the at least one characteristic to improve the determined likelihood of the team accomplishing the goal associated with the project.

11. The method of claim 1 further comprising identifying, by the optimization engine, at least one characteristic of the team correlated with a modification to the determined likelihood of the team accomplishing the goal associated with the organization.

12. The method of claim 11 further comprising:
generating, by the optimization engine, a survey to provide to the members of the team having the at least one characteristic, the survey presenting at least one question associated with the performance of the team;
sending, by the optimization engine, the survey to the members of the team according to a predetermined schedule;
analyzing, by the optimization engine, at least one received response to the survey; and
determining, by the optimization engine, a second modification to the likelihood of the team accomplishing the goal associated with the organization, responsive to the analyzing of the at least one received response to the survey.

13. The method of claim 11 further comprising identifying, by the optimization engine, an action to assign to the members of the team having the at least one characteristic to improve the determined likelihood of the team accomplishing the goal associated with the organization.

14. The method of claim 1 further comprising:
receiving, by the optimization engine, via the user interface, user input instructing the optimization engine to modify an identification of the members of the team to replace one member of the team with a second member of the at least one organization;
modifying, by the optimization engine, the identification responsive to the user input;
analyzing, by the optimization engine, data relating to at least one characteristic of the second member;
determining, by the optimization engine, a level of contribution of the second member to the goal associated with the at least one organization;
determining, by the optimization engine, a level of contribution of the second member to the goal associated with the project;
determining, by the optimization engine, a likelihood of the modified team accomplishing the goal associated with the project; and
modifying, by the optimization engine, a user interface displaying a visualization of the determinations of the optimization engine when the team includes the second member instead of the first member.

15. The method of claim 1 further comprising:
analyzing, by the optimization engine, data relating to at least one characteristic of a second member of the at least one organization;
modifying, by the optimization engine, an identification of the members of the team to replace one member of the team with the second member of the at least one organization;
determining, by the optimization engine, a level of contribution of the second member to the goal associated with the at least one organization;
determining, by the optimization engine, a level of contribution of the second member to the goal associated with the project;
determining, by the optimization engine, a likelihood of the modified team accomplishing the goal associated with the project; and
modifying, by the optimization engine, a user interface to display a visualization of the determinations of the optimization engine when the team includes the second member instead of the first member and to include a recommendation to modify the team to include the second member.

16. A method for generating performance optimization recommendations and modifying a user interface displaying at least one visualization of performance-related data, the method comprising:
accessing, by an optimization engine, data identifying a goal associated with a project;
accessing, by the optimization engine, data identifying a goal associated with at least one organization having at least one member available for assignment to the project;
analyzing, by the optimization engine, data relating to at least one characteristic of the at least one member;
identifying a proposed team including a plurality of members to assign to the project;
determining, by the optimization engine, a level of contribution of each of the plurality of members of the proposed team to the goal associated with the at least one organization;
determining, by the optimization engine, a level of contribution of each of the plurality of members of the proposed team to the goal associated with the project;
determining, by the optimization engine, a likelihood of the team accomplishing the goal associated with the project; and
modifying, by the optimization engine, a user interface displaying a visualization of the determinations of the optimization engine.

17. The method of claim 16 further comprising:
determining, by the optimization engine, that a second member of the organization is available for assignment to the project and provides a higher level of contribution to the goal associated with the project; and
modifying the proposed team to include the second member of the organization.

18. The method of claim 16 further comprising:
determining, by the optimization engine, that a second member of the organization is available for assignment to the project and provides a higher level of contribution to the goal associated with the organization; and
modifying the proposed team to include the second member of the organization.
